(19) United States
(12) Patent Application Publication
(10) Pub. No.: US 2021/0040623 A1
(43) Pub. Date: Feb. 11, 2021

(54) SAFETY SYSTEM AND METHOD FOR DE-COUPLING OF A CATHODICALLY PROTECTED STRUCTURE

(71) Applicant: Cathtect Engineering (Pty) Ltd., Roodepoort (ZA)

(72) Inventor: David John Raath, Roodekrans (ZA)

(21) Appl. No.: 16/986,025

(22) Filed: Aug. 5, 2020

Related U.S. Application Data
(60) Provisional application No. 62/884,425, filed on Aug. 8, 2019.

(51) Int. Cl. C23F 13/04; C23F 13/06; H02H 7/26

(52) U.S. Cl. CPC C23F 13/04; C23F 2213/32; H02H 7/26; C23F 13/06

(57) ABSTRACT

The present disclosure is for a safety system for de-coupling of a cathodically protected structure. The safety system comprises both a DC (Direct Current) component, connected or connectable between the structure and ground, and an AC (Alternating Current) component, connected or connectable between the structure and ground and connected in parallel with the DC component. The safety system also comprises a switch connected in series with the AC component, the switch configured selectively to disconnect the AC component between the structure and ground while permitting the DC component to remain connected between structure and ground.

### CROSS REFERENCE TO RELATED APPLICATION

This application claims the benefit of priority to U.S. Provisional Patent Application No. 62/884,425, filed on Aug. 8, 2019, the disclosure of which is hereby expressly incorporated by reference in its entirety.

### FIELD OF DISCLOSURE

This disclosure relates to cathodic protection, and specifically to a safety system and method of de-coupling cathodically protected structures, e.g., pipelines.

### BACKGROUND OF DISCLOSURE

Cathodic protection of structures, for example pipelines, is known in the art (https://en.wikipedia.org/wiki/Cathodic_protection#Applications, accessed 6 Aug. 2019). Cathodic protection is a method of corrosion control whereby the corrosion is transferred to a known body, such as a partially inert anode, away from the structure under its protection. In addition, the Applicant is aware of a current practice whereby, where required, solid-state de-couplers incorporating AC mitigation methods are deployed on structures and pipelines where alternating current (AC) needs to be de-coupled to ground and Direct Current (DC) thresholds need to be preserved and when exceeded DC currents need to be contained and controlled, especially where cathodic protection has been applied.

Cathodic protection generally utilizes two methods, namely sacrificial anode cathodic protection and impressed current cathodic protection, the latter being utilized where higher driving voltages are required. The former method, sacrificial anode cathodic protection, has a limited source impedance and may be benign with regard to generation of hazardous voltages.

Techniques to determine a level of cathodic protection and/or a condition of coatings of buried infrastructure comprise a switching technique applied whereby the cathodic protection current is regularly interrupted to ascertain an “off and on” waveform. The results of the wave form are utilized to determine whatever it is the application requires.

For safety reasons, structures under cathodic protection (i.e., cathodically protected structures) may need to, or it may be desired to, de-couple the structures, with respect to AC and/or DC, relative to ground. De-coupling safety systems, for example, solid-state devices, have been created to perform this de-coupling.

Capacitances utilized in solid-state de-couplers however modify the applied waveform and distort the evidence obtained from the interruption process. In order to avoid the waveform modification, the solid-state de-coupling devices are disconnected from the infrastructure for the duration of the testing and thereby the very reason for installing the de-couplers, to prevent human accident and shocks, is compromised.

### SUMMARY OF DISCLOSURE

Accordingly, the disclosure provides a safety system for de-coupling of a cathodically protected structure, the safety system comprising:
a DC (Direct Current) component, connected or connectable between the structure and ground;
an AC (Alternating Current) component, connected or connectable between the structure and ground and connected in parallel with the DC component; and
a switch connected in series with the AC component, the switch configured selectively to disconnect the AC component between the structure and ground while permitting the DC component to remain connected between structure and ground.

The disclosure extends to a method of de-coupling of a cathodically protected structure, the method comprising:
providing a DC (Direct Current) component, connected between the structure and ground;
providing an AC (Alternating Current) component, connected between the structure and ground and in parallel with the DC component;
providing a switch connected in series with the AC component; and
actuating the switch, thereby to selectively disconnect the AC component between the structure and ground while permitting the DC component to remain connected between structure and ground.

The switch may be in the form of an isolator.

There may be plural AC components and/or DC components.

There may be additional electrical or electronic components connected or connectable between the structure and ground, for example, connected in parallel with the AC component and the switch. Actuation or disconnection of the switch may not disconnect the additional electrical or electronic components. The additional electrical or electronic components may include circuit elements, like diodes, trigger circuits, resistive and/or reactive elements, etc.

The DC component may include at least one diode, gas discharge tube, thyristor, a DC mitigation circuit and/or a DC control element. The AC component may include a reactive element, an AC mitigation circuit and/or AC de-coupler.

The safety system may be provided by one, or at least one, solid-state device package. The switch may be accessible from an exterior of the solid-state device package. The switch may be actuated by wire or wirelessly.

The method may comprise:
opening or disconnecting the switch during testing; and
closing or connecting the switch during normal operation.

### BRIEF DESCRIPTION OF DRAWINGS

The disclosure will now be further described, by way of example, with reference to the accompanying diagrammatic drawings.

In the drawings:

FIG. 1 shows a schematic circuit diagram of a PRIOR ART de-coupling system for a cathodically protected structure (e.g., a pipe structure) as represented by circuit components;

FIG. 2 shows a schematic circuit diagram of a first embodiment of a PRIOR ART de-coupling system for a cathodically protected structure;

FIG. 3 shows a schematic circuit diagram of a first embodiment of a safety system for de-coupling of a cathodically protected structure, in accordance with the present disclosure;

FIG. 4 shows a schematic circuit diagram of a second embodiment of a PRIOR ART de-coupling system for a cathodically protected structure;

FIG. 5 shows a schematic circuit diagram of a second embodiment of a safety system for de-coupling of a cathodically protected structure, in accordance with the present disclosure;

FIG. 6 shows a schematic circuit diagram of a third embodiment of a PRIOR ART de-coupling system for a cathodically protected structure;

FIG. 7 shows a schematic circuit diagram of a third embodiment of a safety system for de-coupling of a cathodically protected structure, in accordance with the present disclosure;

FIG. 8 shows a schematic circuit diagram of a fourth embodiment of a PRIOR ART de-coupling system for a cathodically protected structure;

FIG. 9 shows a schematic circuit diagram of a fourth embodiment of a safety system for de-coupling of a cathodically protected structure, in accordance with the present disclosure;

FIG. 10 shows a schematic circuit diagram of a fifth embodiment of a PRIOR ART de-coupling system for a cathodically protected structure; and

FIG. 11 shows a schematic circuit diagram of a fifth embodiment of a safety system for de-coupling of a cathodically protected structure, in accordance with the present disclosure.

### DETAILED DESCRIPTION OF EXAMPLE EMBODIMENT

The following description of the disclosure is provided as an enabling teaching of the disclosure. Those skilled in the relevant art will recognize that many changes can be made to the embodiment described, while still attaining the beneficial results of the present disclosure. It will also be apparent that some of the desired benefits of the present disclosure can be attained by selecting some of the features of the present disclosure without utilizing other features. Accordingly, those skilled in the art will recognize that modifications and adaptations to the present disclosure are possible and can even be desirable in certain circumstances and are a part of the present disclosure. Thus, the following description is provided as illustrative of the principles of the present disclosure and not a limitation thereof.

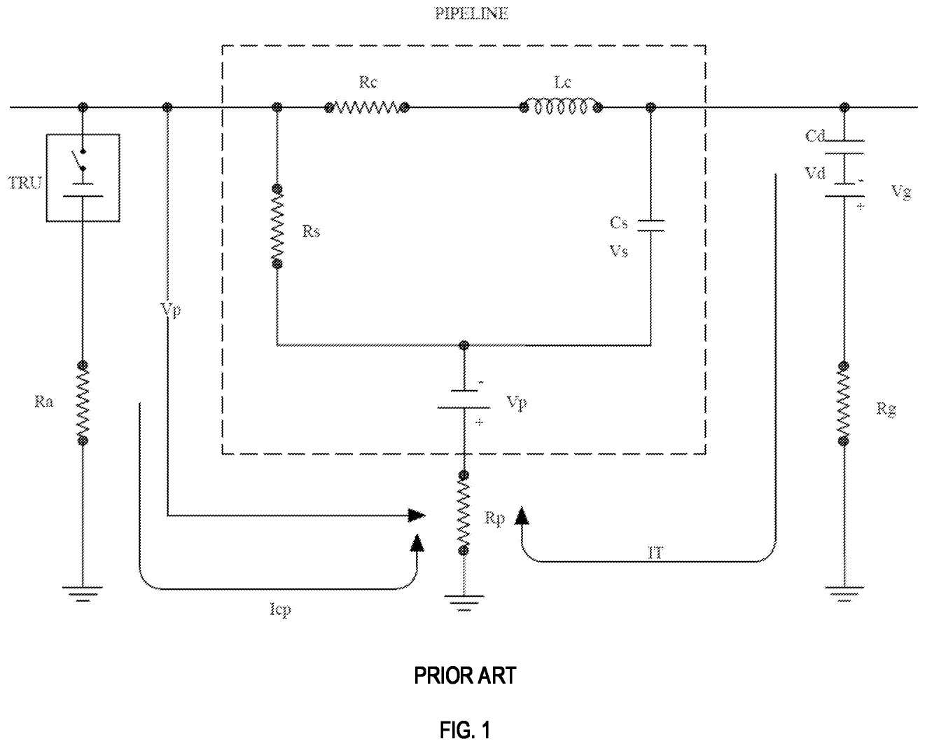

FIG. 1 illustrates a PRIOR ART structure in the form of a pipeline, with cathodic protection, illustrated as a circuit. The following table (Table 1) provides an explanation of references used in FIG. 1:

TABLE 1

| | |
|---|---|
| Ra | Anode resistance |
| TRU | Cathodic protection source |
| Icp | Cathodic protection current |
| Rs | Pipe-to-soil resistance |
| Cs | Pipe-to-soil capacitance |
| Vs | Pipe-to-soil voltage |
| Vp | Polarized potential |
| Rp | Polarized resistance |
| Cd | De-coupler AC mitigation capacitance |
| Vd | De-coupler AC mitigation voltage |
| Rg | De-coupler-to-soil resistance |
| IT | Transient current |

The circuit satisfies the following formula:

(Icp×Rp)+Vp+Vs=Vg+Vd (1)

Icp may need to be interrupted to obtain values or reading for one or more of:
various instantaneous values;
DC component of Vg; and/or
coating conductance.

Also, Vd will change by Icp×Rp after Icp is interrupted.

In clustered rights-of-way and sharing of servitudes in today's times, buried pipelines are often subjected to induced currents from overhead powerlines and the associated imbalances within those powerlines may cause unwanted currents to flow in the pipelines. With presence of high-quality coatings, pipelines are largely insulated and wherever testing facilities are installed to determine the level of cathodic protection, these very test facilities and operation appurtenances become hazardous to those operating and handling equipment in the process of their work on the pipelines.

In order to ensure that any AC voltage induced onto the pipeline or overvoltage condition that arises is effectively removed, solid state de-couplers are deployed. For the AC component to be effectively dealt with, inductive and/or capacitive reactance's connected between the structure and ground provide a pathway for AC to be connected to ground without bleeding of the necessary DC injected by the cathodic protection system.

In some PRIOR ART solid-state de-coupling devices deployed, a further DC mechanism is added to ensure that should the DC rise above or below a specified level, it too, gets shunted away to ground thereby limiting the possible voltage that could appear on the structure pipeline to ground both AC as well as DC.

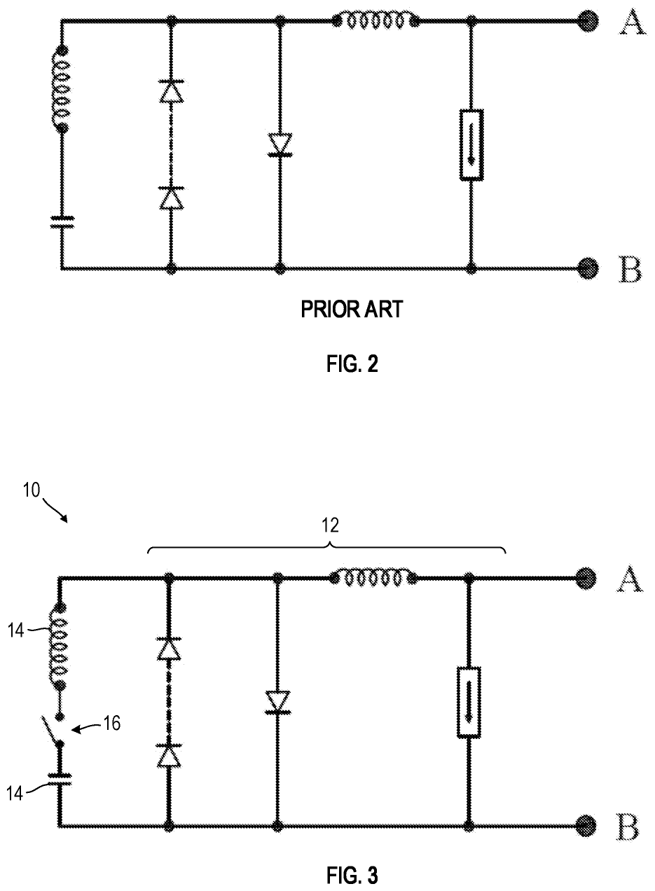

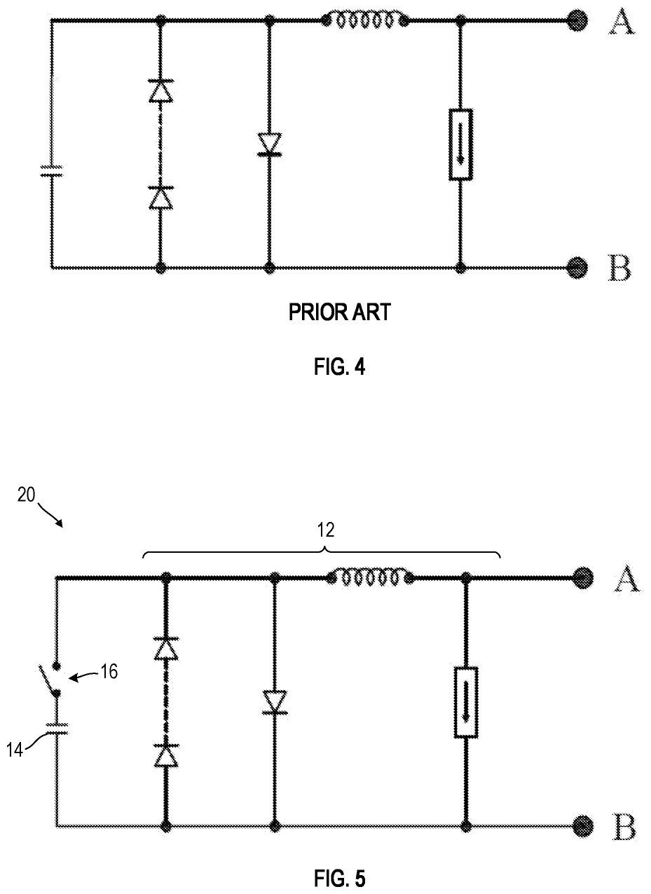

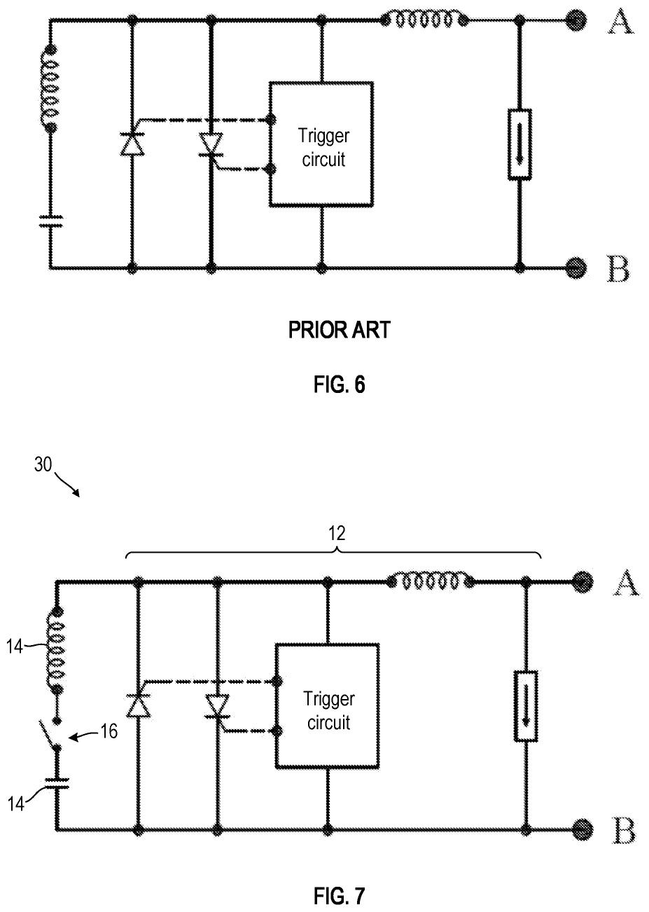

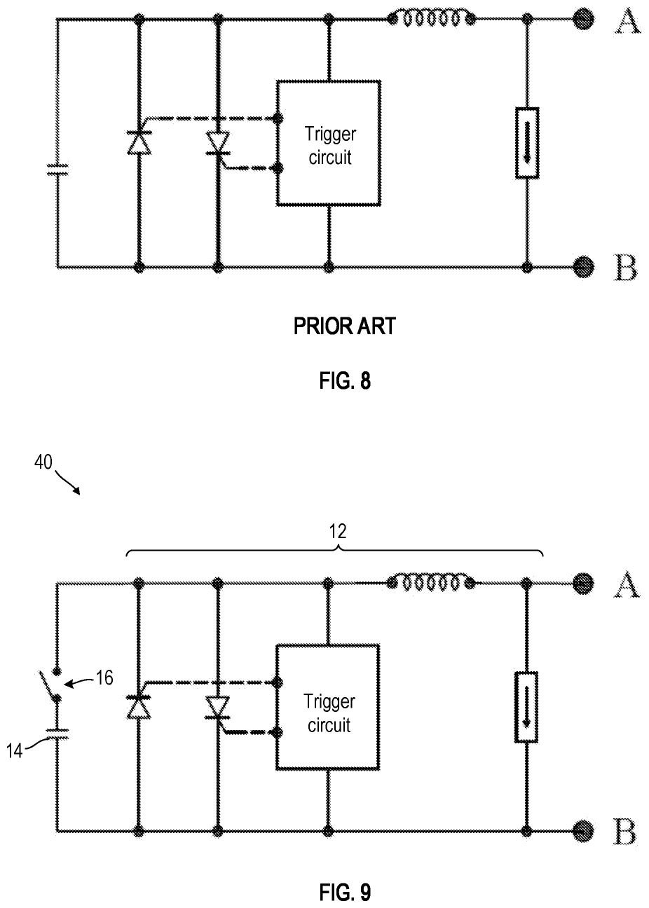

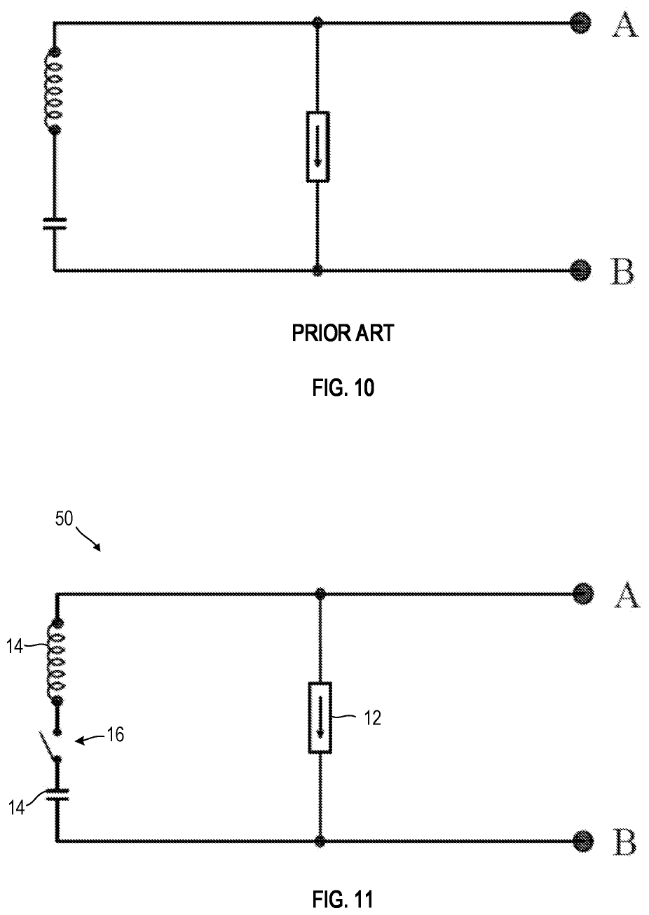

Various PRIOR ART de-coupling systems for cathodically protected structure exist, which are typically in the form of solid-state or electrolytic de-couplers. Variants of which the Applicant is aware are illustrated in FIGS. 2, 4, 6, 8 and 10. They have common elements in that each comprise both a DC component (e.g., a gas discharge tube and/or diodes) represented in the FIGS. by a resistor/fuse symbol containing a downward arrow and various diodes, and an AC component represented in the FIGS. by a capacitor symbol optionally with an inductor (depending on the variant).

The de-coupling system for a cathodically protected structures system is usually connected between the structure (the pipeline, in these examples) at contact point A and ground at contact point B.

FIGS. 3, 5, 7, 9 and 11 illustrate various embodiments of safety systems 10, 20, 30, 40, 50 for de-coupling of a cathodically protected structure (further referred to, by way of example, as a pipeline). In each safety system 10, 20, 30, 40, 50, the following components are provided:
a DC component 12, including at least a gas discharge tube which, for the purposes of this specification, is included in the definition of a DC component;
an AC component 14; and
a switch 16.

The DC component 12 is provided between contact points A and B and is thus configured to be connected between the pipeline (contact point A) and ground (contact point B). The AC component 14 is also provided between points A and B and is similarly configured to be connected between the pipeline and ground. The AC component 14 is in parallel with the DC component 12 and there may be additional DC components 12, for example, in parallel between the gas discharge tube and AC component 14. The AC component 14 is a reactive component.

Importantly, a switch 16 (e.g., in the form of an isolator) is inserted in series with the AC component 14. Thus, connection or disconnection of the switch operatively connects or disconnects the AC component 14 between the contact points A and B, and thus between the pipeline and ground.

The various safety systems 10, 20, 30, 40, 50 differ in minor ways:
In the safety systems 10, 30, 50, the AC component comprises a capacitor and inductor, while in the safety system 20, 40, it comprises a capacitor only.
The safety system 10, 20, 30, 40 have additional DC components 12 in the form of diodes, whereas the safety system 50 does not.
The additional DC components 12 of the systems 10, 20 comprise only diodes, while the additional DC components 12 of the safety systems 30, 40 also comprise a trigger circuit.

However, in all of the safety systems 10, 20, 30, 40, 50, the same principle is overarching: the switch 16 is configured to disconnect the AC component 14 but not the DC component 12.

The DC component 12 is not necessarily limited to DC components and may include AC or reactive components (e.g., an inductor as in some of the FIGS.) or other circuitry.

The safety system 10, 20, 30, 40, 50 may be implemented in a solid-sate package. A rating of the switch 16 or isolator may be determined at manufacture based upon steady state conditions for which the safety system 10, 20, 30, 40, 50 is designed, and may be configured to handle multiple operations.

The safety system 10, 20, 30, 40, 50 may have the following technical uses and advantages.

As the AC component 14 is, at least partially, responsible for modifying or distorting electric signals or waves, by disconnecting the AC component 14, such wave-modifying components can be temporarily removed, leaving the DC components 12 still connected, thereby to limit both the DC current that might be on the pipeline as well as any AC on the pipeline. This has the effect that any AC or DC voltages may be reduced to accepted levels and clamped by the DC components without exposing people (e.g., maintenance workers) to undue electrical hazards and/or modifying the applied testing waveform.

Accordingly, the switch 16 may be used to disconnect the AC component 14 only temporarily while tests or maintenance are performed. During this testing or maintenance period, the gas discharge tube of the DC component 12 will continue to be connected, thus enhancing safety. The switch 16 can be closed to reconnect the AC component 14 when testing and maintenance is concluded. It may be advantageous to have the diodes and the discharge tube 12 continually connected to maintain safety without distorting the waveform.

1. A safety system for de-coupling of a cathodically protected structure, the safety system comprising:
a DC (Direct Current) component, connected or connectable between the structure and ground;
an AC (Alternating Current) component, connected or connectable between the structure and ground and connected in parallel with the DC component; and
a switch connected in series with the AC component, the switch configured selectively to disconnect the AC component between the structure and ground while permitting the DC component to remain connected between structure and ground.

2. The safety system as claimed in claim 1, wherein the switch is in the form of an isolator.

3. The safety system as claimed in claim 1, wherein there are plural AC components and/or DC components.

4. The safety system as claimed in claim 1, wherein there are additional electrical or electronic components connected or connectable between the structure and ground.

5. The safety system as claimed in claim 4, wherein actuation or disconnection of the switch does not disconnect the additional electrical or electronic components.

6. The safety system as claimed in claim 1, wherein the DC component includes at least one diode, gas discharge tube, thyristor, a DC mitigation circuit and/or a DC control element.

7. The safety system as claimed in claim 1, wherein the AC component includes a reactive element, an AC mitigation circuit and/or AC de-coupler.

8. The safety system as claimed in claim 1, which is provided by a solid-state device package.

9. The safety system as claimed in claim 8, wherein the switch is accessible from an exterior of the solid-state device package.

10. A method of de-coupling of a cathodically protected structure, the method comprising:
providing a DC (Direct Current) component, connected between the structure and ground;
providing an AC (Alternating Current) component, connected between the structure and ground and in parallel with the DC component;
providing a switch connected in series with the AC component; and
actuating the switch configured, thereby to selectively disconnect the AC component between the structure and ground while permitting the DC component to remain connected between structure and ground.

11. The method as claimed in claim 10, comprising:
opening or disconnecting the switch during testing; and
closing or connecting the switch during normal operation.
